(19) United States
(12) Patent Application Publication
(10) Pub. No.: US 2013/0186341 A1
(43) Pub. Date: Jul. 25, 2013

(54) PET COMFORTER

(71) Applicants: Kelly McCormack, Peoria, AZ (US); Alice Granado, Peoria, AZ (US)

(72) Inventors: Kelly McCormack, Peoria, AZ (US); Alice Granado, Peoria, AZ (US)

(21) Appl. No.: 13/737,096

(22) Filed: Jan. 9, 2013

Related U.S. Application Data
(60) Provisional application No. 61/589,648, filed on Jan. 23, 2012.

(51) Int. Cl. A01K 29/00

(52) U.S. Cl. CPC A01K 29/00
USPC 119/28.5

(57) ABSTRACT

A pet cover attached to an item of top bedding for a human and having access for a pet to enter under the pet cover. The pet cover may be permanently or releasably attached to the bed covering. The pet cover may be multi-layered fabric, including a water resistant fabric and/or fabrics impregnated with antibacterial, antimicrobial, pesticidal, or various other special purpose additives. Various shapes, attachments, and configurations are illustrated. The invention may be provided as a first kit with a bed covering for a human and multiple interchangeable pet covers. The invention may be provided as a second kit with user-installable fasteners for a legacy bed covering and one or more pet covers.

### RELATED APPLICATIONS

This application claims the benefit of U.S. provisional patent application 61/589,648 filed Jan. 23, 2012 with two common inventors.

### TECHNICAL FIELD

The present invention relates to pet bedding generally and to integrated human bedding and pet bedding for concurrent use by a human and a pet specifically.

### BACKGROUND

Pets, especially dogs and cats, sometimes like to sleep on a bed that is designed for and in use by one or more humans. Some pets also sometimes prefer to sleep under a blanket. Humans sometimes enjoy having a pet sleeping on the bed that the humans are using, put have concerns regarding sanitation and infestation.

### OBJECTS AND FEATURES OF THE PRESENT INVENTION

It is an object of the present invention to provide a pet comforter that is either releasably or fixedly attached to a comforter or similar top bedding for a human bed. It is another object of the present invention to provide a pet comforter that is attached to the human top bedding on most of the perimeter of the pet comforter and having an unattached portion of the perimeter by which the pet can enter under the pet comforter. It is another object of the present invention to provide a pet comforter that includes antimicrobial materials. It is another object of the present invention to provide a pet comforter that has air vents. It is another object of the present invention to provide a pet comforter that includes multiple layers of fabric. It is another object of the present invention to provide a pet comforter that suppresses fleas and ticks. It is another object of the present invention to provide a pet comforter that is washable. It is another object of the present invention to provide pet comforters in various sizes and shapes.

It is a feature of the present invention to provide a pet comforter that is either releasably or fixedly attached to a comforter or similar top bedding for a human bed. It is another feature of the present invention to provide a pet comforter that is attached to the human top bedding on most of the perimeter of the pet comforter and having an unattached portion of the perimeter by which the pet can enter under the pet comforter. It is another feature of the present invention to provide a pet comforter that includes antimicrobial materials. It is another feature of the present invention to provide a pet comforter that has air vents. It is another feature of the present invention to provide a pet comforter that includes multiple layers of fabric. It is another feature of the present invention to provide a pet comforter that suppresses fleas and ticks. It is another feature of the present invention to provide a pet comforter that is washable. It is another feature of the present invention to provide pet comforters in various sizes and shapes.

### BRIEF DESCRIPTION OF THE DRAWINGS

The present invention will hereinafter be described in conjunction with the following drawing figures, wherein like numerals denote like elements, and

FIG. 1 is a perspective view illustrating an exemplary pet comforter on a bed, in accordance with a preferred embodiment of the present invention;

FIG. 2 is a perspective view illustrating another exemplary pet comforter on a bed, in accordance with a second preferred embodiment of the present invention;

FIG. 3 is a perspective view illustrating another exemplary pet comforter on a bed, in accordance with a third preferred embodiment of the present invention;

FIG. 4 is a perspective view illustrating another exemplary pet comforter on a bed, in accordance with a fourth preferred embodiment of the present invention;

FIG. 5 is a perspective view illustrating another exemplary pet comforter on a bed, in accordance with a fifth preferred embodiment of the present invention;

FIG. 6 is a perspective view illustrating another exemplary pet comforter on a bed, in accordance with a sixth preferred embodiment of the present invention;

FIG. 7 is a perspective view illustrating another exemplary pet comforter on a bed, in accordance with a seventh preferred embodiment of the present invention;

FIG. 8 is a perspective view illustrating another exemplary pet comforter on a bed, in accordance with an eighth preferred embodiment of the present invention;

FIG. 9 is a perspective view illustrating another exemplary pet comforter on a bed, in accordance with a ninth preferred embodiment of the present invention;

FIG. 10 is a perspective view illustrating another exemplary pet comforter on a bed, in accordance with a tenth preferred embodiment of the present invention;

FIG. 11 is a perspective view illustrating another exemplary pet comforter on a bed, in accordance with a eleventh preferred embodiment of the present invention;

FIG. 12 is a perspective view illustrating another exemplary pet comforter on a bed, in accordance with a twelfth preferred embodiment of the present invention;

FIG. 13 is a perspective view illustrating another exemplary pet comforter on a bed, in accordance with a thirteenth preferred embodiment of the present invention;

FIG. 14 is a diagrammatic view illustrating an exemplary embodiment of a first pet comforter kit, in accordance with a preferred embodiment of the present invention; and

FIG. 15 is a diagrammatic view illustrating an exemplary embodiment of a second pet comforter kit, in accordance with a preferred embodiment of the present invention.

### DETAILED DESCRIPTION OF THE PREFERRED EMBODIMENTS

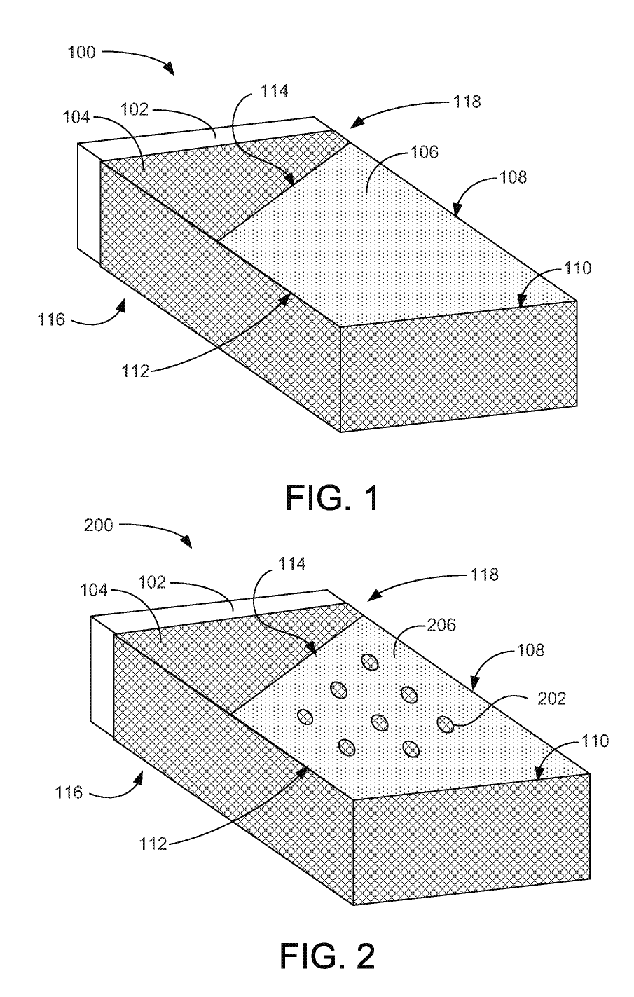

FIG. 1 is a perspective view illustrating an exemplary pet comforter 100 on a bed 102, in accordance with a preferred embodiment of the present invention. Pet comforter 100 includes top bedding 104 and pet cover 106. Bed 102, which may be of any useful size, releasably supports top bedding 104, which includes top portion 118 and skirt portion 116. Top bedding 104 may be a comforter, blanket, duvet, or other top layer of human bedding. Pet cover 106 is preferably at least one layer of fabric and is attached to top bedding 104 along the bottom edge 110 and side edges 108 and 112. Top edge 114 of pet cover 106 is not attached to top bedding if pet cover 106 is a single layer of fabric. In embodiments in which pet cover 106 is made of multiple layers of fabric, at least one of the layers is not attached to the top bedding 104 along top edge 114, thereby allowing entry of a pet under pet cover 106. Preferably, edges 108, 110, and 112 coincide with edges of the bed 102. Top bedding 104 and pet cover 106 may be of various fabric materials in various embodiments and may bear decoration, such as colors and/or patterns. Preferably, all materials are ecologically friendly materials. While illustrated as flat, pet cover 106 may have slack to accommodate a pet. The pet comforter 100 is preferably sold as the top bedding 104 with pet cover 106 attached.

FIG. 2 is a perspective view illustrating another exemplary embodiment of pet comforter 200 on a bed 102, in accordance with a second preferred embodiment of the present invention. Pet comforter 200 includes top bedding 104 and pet cover 206. In this embodiment of pet comforter 100, pet cover 206 includes air vents 202 (one of eight labeled). In various embodiments, air vents 202 may be of various sizes and shapes and may be one or more air vents 202. The pet comforter 200 is preferably sold as the top bedding 104 with pet cover 206 attached.

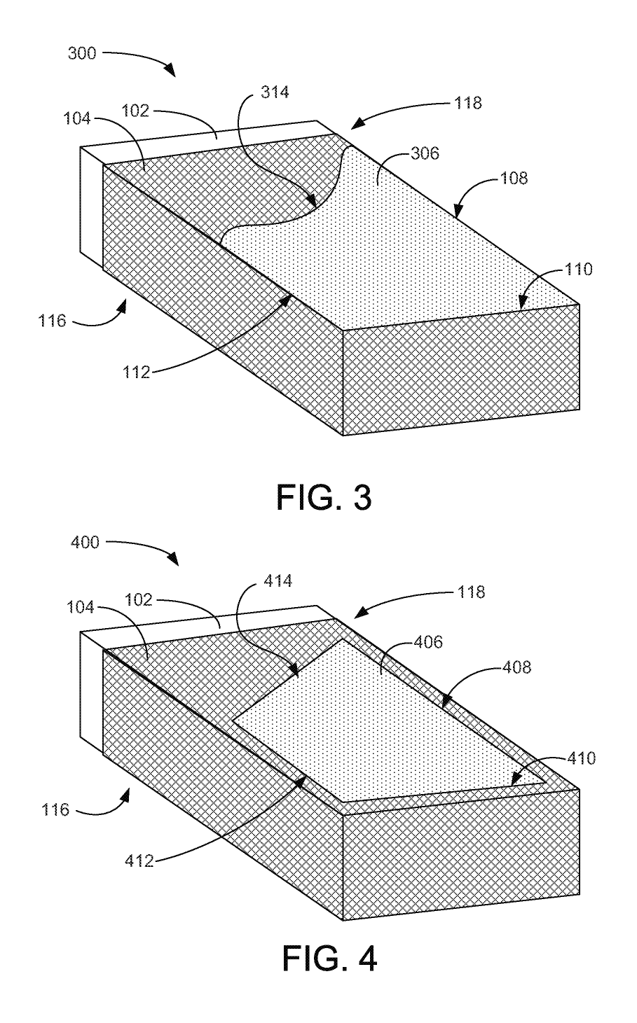

FIG. 3 is a perspective view illustrating another exemplary embodiment of a pet comforter 300 on a bed 102, in accordance with a third preferred embodiment of the present invention. Pet comforter 300 includes top bedding 104 and pet cover 306. Pet cover 306 has an irregular curved top edge 314 illustrative, without limitation, of the variation in shape that the top edge 314 may have. The pet comforter 300 is preferably sold as the top bedding 104 with pet cover 306 attached.

FIG. 4 is a perspective view illustrating another exemplary embodiment pet comforter 400 on a bed 102, in accordance with a fourth preferred embodiment of the present invention. Pet comforter 400 includes top bedding 104 and pet cover 406. Pet cover 406 has edges 408, 410, 412 attached to top bedding 104. Edges 408, 410, 412 do not extend to the respective edges of bed 102. Top edge 414 is open to permit entry of a pet. In some embodiments, only one or two of edges 408, 410, 412 do not extend to the respective edges of bed 102. The pet comforter 400 is preferably sold as the top bedding 104 with pet cover 406 attached.

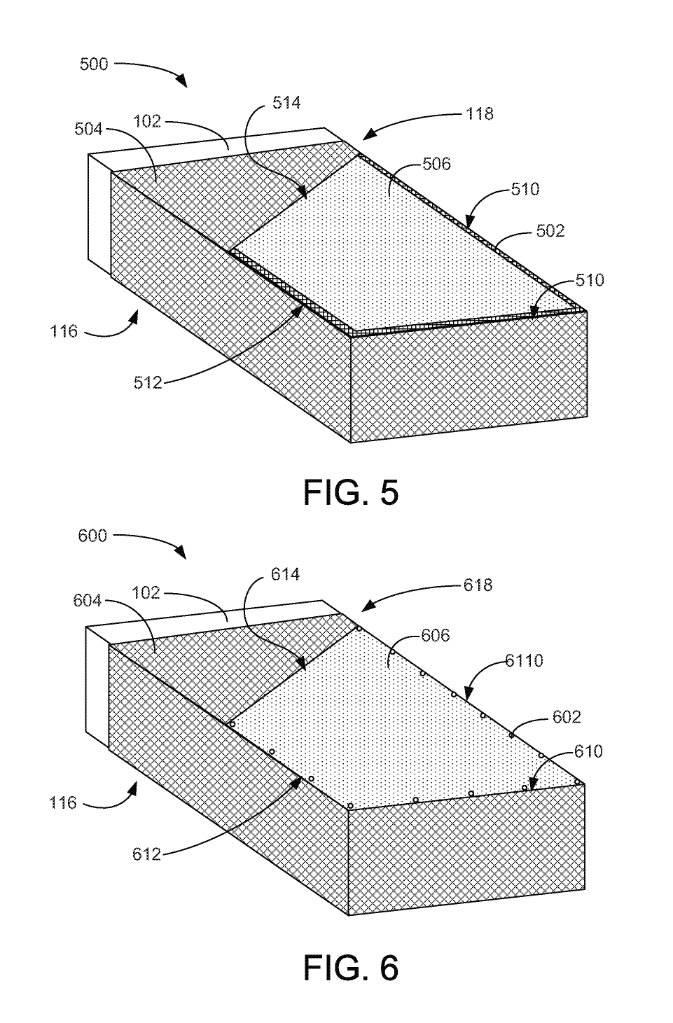

FIG. 5 is a perspective view illustrating another exemplary embodiment of a pet comforter 500 on a bed 102, in accordance with a fifth preferred embodiment of the present invention. Pet comforter 500 includes top bedding 504 and pet cover 506. Pet cover 506 has a continuous releasable fastener 502 along edges 510, 512, and 512. Releasable fastener 502 may be, for non-limiting examples, a zipper, hook and loop fastener, and a press-seal fastener. Top edge 514 is open to permit entry of a pet. Top bedding 504 includes a complimentary part of fastener 502. The pet comforter 500 is preferably sold as the top bedding 104 with one or more pet covers 506. In a particular embodiment, pet cover 506 may be reversible.

FIG. 6 is a perspective view illustrating another exemplary embodiment of a pet comforter on a bed, in accordance with a sixth preferred embodiment of the present invention. Pet comforter 600 includes top bedding 604 and pet cover 606. Pet cover 606 includes spaced-apart releasable fasteners 602 (one of fifteen labeled) along edges 610, 612, and 612. Releasable fasteners 602 may be, for non-limiting examples, snaps, buttons, hook and loop fasteners, hooks, ties, hook and eye fasteners, and buckles. Top edge 614 is open to permit entry of a pet. Top bedding 604 includes complimentary parts of fasteners 602. In a particular embodiment, complimentary parts of fasteners 602 are arrayed around the top portion 618 of top bedding 604 to permit variation in the positioning, by the user, of pet cover 606 on top bedding 604. The pet comforter 600 is preferably sold as the top bedding 104 with one or more pet covers 606.

In the embodiments of FIG. 5 and FIG. 6, the pet comforter 500 or 600 may be sold with a plurality of various pet covers 506 or 606, respectively, each having a different weight and/or air permeability for various seasons, applications, and pets. Likewise, the plurality of various pet covers 506 or 606 may have various colors, designs, and/or patterns in various embodiments. One or more of the plurality of various pet covers 506 or 606 may be reversible. In a particular embodiment, the combination of the top bedding 504 and the plurality of releasably attachable pet covers 506 or 606 may be sold as a first kit. In another approach, the top bedding 504 or 604 may be sold online with a consumer's choice of one or more pet covers 506 or 606, respectively, made in the same online sale. In another particular embodiment, the plurality of releasably attachable pet covers 506 or 606 may be sold as a second kit including a plurality of first parts of complimentary fasteners 502 or 602 operable to be attached to a consumer's legacy bed covering 504 or 604 by the consumer and second parts of such complimentary fasteners 502 or 602 attached to the pet cover 506 or 606.

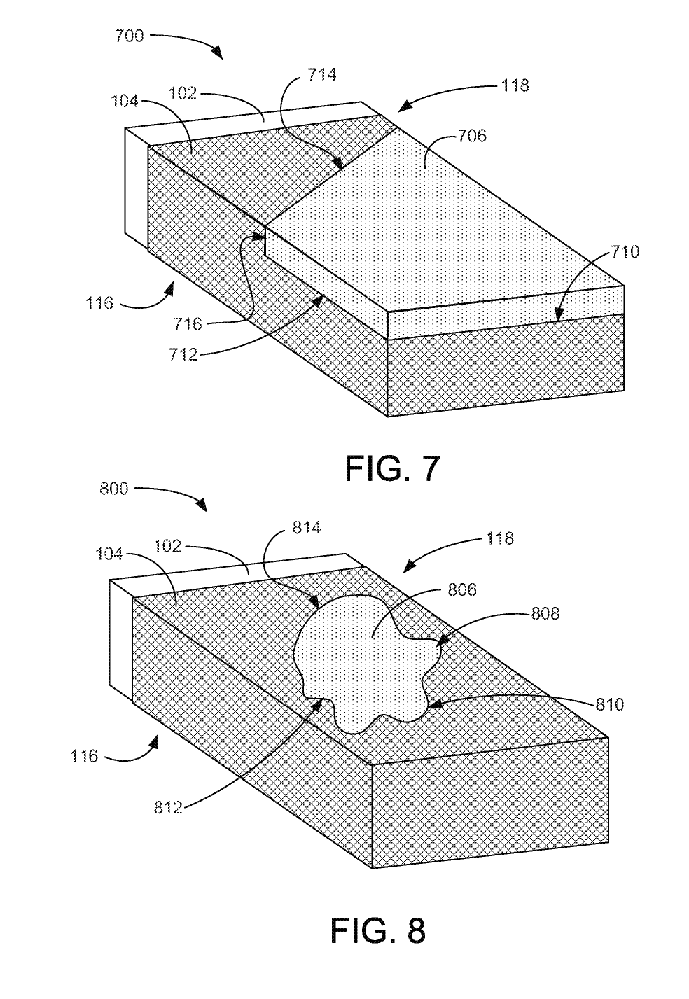

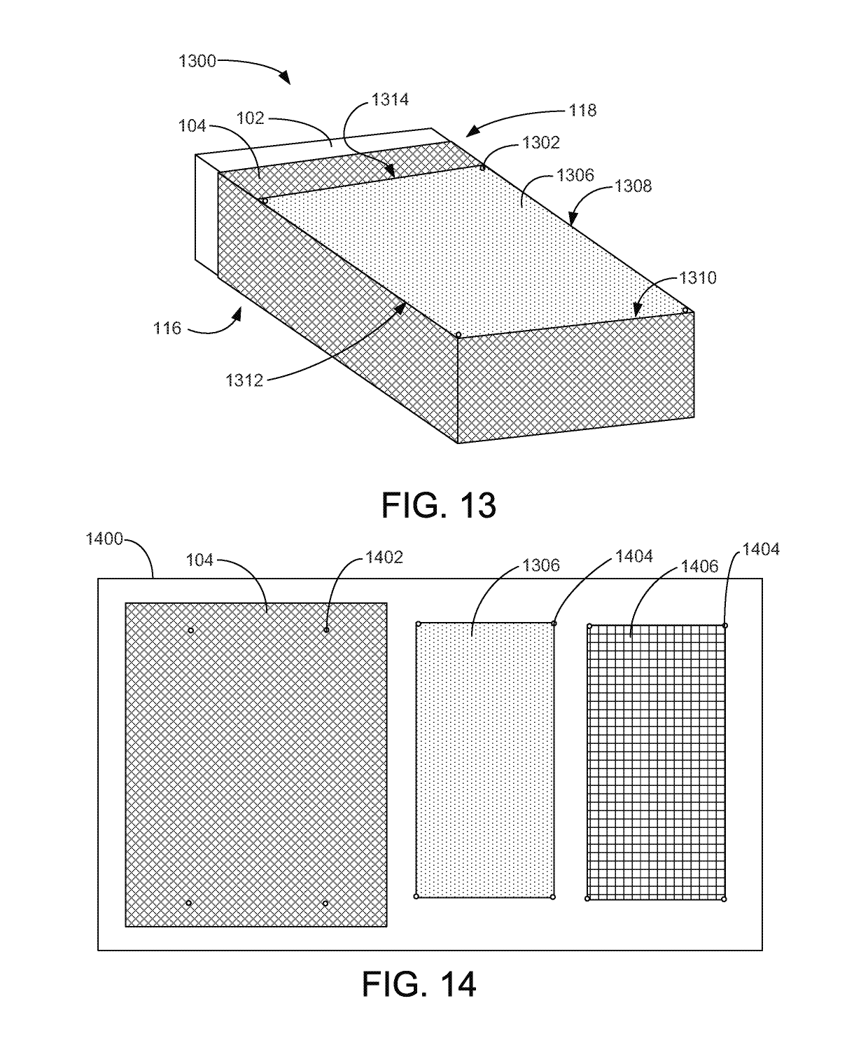

FIG. 7 is a perspective view illustrating another exemplary embodiment of a pet comforter 700 on a bed 102, in accordance with a seventh preferred embodiment of the present invention. Pet comforter 700 includes top bedding 104 and pet cover 706. Side and bottom edges 712, 716, and 710 of pet cover 706 extend over the edges of bed 102. The extent of the extended edges 710 and 712 may, in a particular embodiment, extend to the bottom edge of bed 102 (see FIG. 12). The side not shown in this illustration also has an extension of the pet cover 706. Top edge 714 is open to permit entry of a pet. The pet comforter 700 is preferably sold as the top bedding 704 with pet cover 706 attached. In a particular embodiment, edge 716 is open, forming a hammock, with a bottom at edge 712, along the side of bed 102, in which a small pet may rest.

FIG. 8 is a perspective view illustrating another exemplary embodiment of a pet comforter 800 on a bed, in accordance with an eighth preferred embodiment of the present invention. Pet comforter 800 includes top bedding 104 and pet cover 806. Pet cover 806 has an irregular shape to exemplify, without limitation, the range of shapes available for pet cover 806. Top edge 814 is open to permit entry of a pet. Edges 808, 810, and 812 are releasably or fixedly attached to top bedding 104. The pet comforter 800 is preferably sold as the top bedding 804 with pet cover 806 attached.

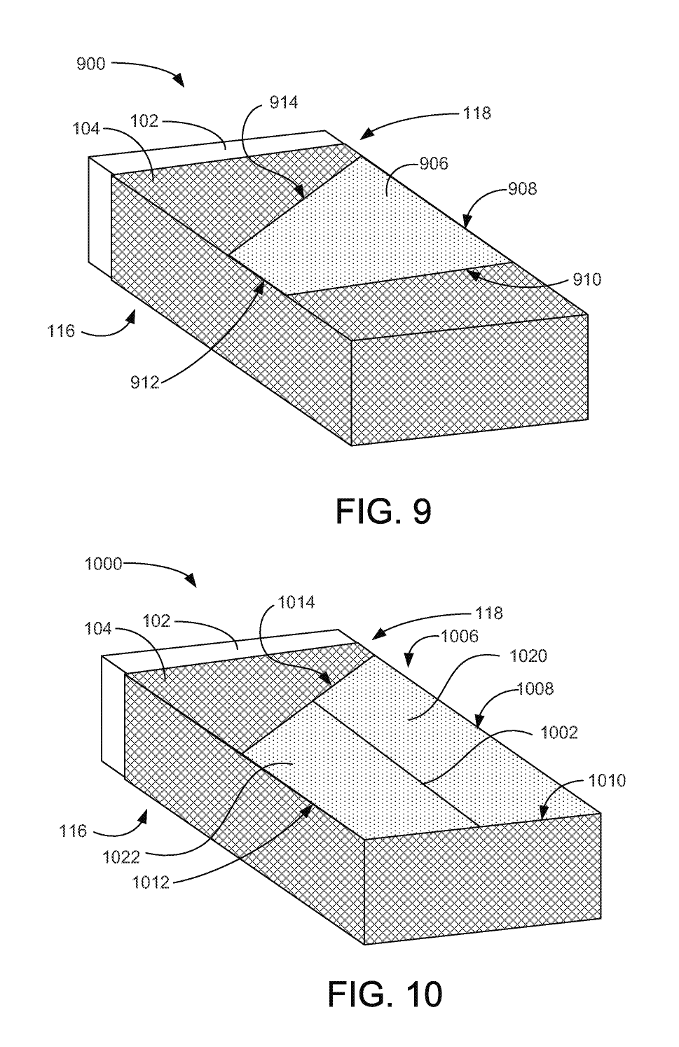

FIG. 9 is a perspective view illustrating another exemplary pet comforter 900 on a bed 102, in accordance with a ninth preferred embodiment of the present invention. Pet comforter 900 includes top bedding 104 and pet cover 906. Pet cover 906 has a bottom edge 910 that is not along the bottom edge of bed 102. Top edge 914 is open to permit entry of a pet. Edges 908, 910, and 912 are releasably or fixedly attached to top bedding 104. In a particular embodiment, the bottom edge 910 of pet cover 906 may be near the bottom edge of bed 102 to provide for a pet that prefers to sleep on the foot of the bed. The pet comforter 900 is preferably sold as the top bedding 904 with pet cover 906 attached.

FIG. 10 is a perspective view illustrating another exemplary embodiment of a pet comforter 1000 on a bed 102, in accordance with a tenth preferred embodiment of the present invention. Pet comforter 1000 includes top bedding 104 and pet cover 1006. Pet cover 1006 has a divider 1002 that divides pet cover 1006 into two compartments 1020 and 1022. The compartments 1020 or 1022 may be used for separating two pets or for providing options for positioning one pet. Top edge 1014 is open to permit entry of a pet. Edges 1008, 1010, and 1012 are releasably or fixedly attached to top bedding 104. In a particular embodiment, compartments 1020 and 1022 may have releasably fastenable top edges 1014 to allow one compartment to be closed off to limit a pet to a particular side of the bed 102. The pet comforter 1000 is preferably sold as the top bedding 1004 with pet cover 1006 attached.

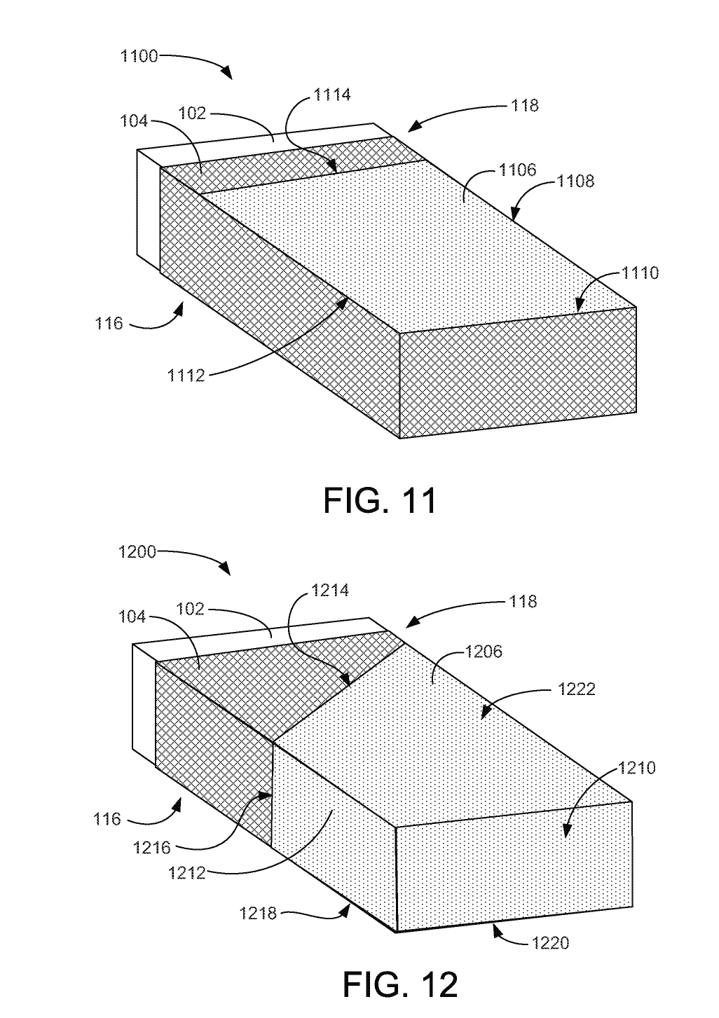

FIG. 11 is a perspective view illustrating another exemplary embodiment of a pet comforter 1100 on a bed 102, in accordance with a eleventh preferred embodiment of the present invention. Pet comforter 1100 includes top bedding 104 and pet cover 1106. Pet comforter 1100 has attached or releasably attached edges 1108, 1110, and 1112 and unattached edge 1114, which is arranged straight across bed 102. The orientation of unattached edge 1114 may vary among various alternate embodiments. The pet comforter 1100 is preferably sold as the top bedding 1104 with pet cover 1106 attached.

FIG. 12 is a perspective view illustrating another exemplary embodiment of a pet comforter 1200 on a bed 102, in accordance with a twelfth preferred embodiment of the present invention. Pet comforter 1200 includes top bedding 104 and pet cover 1206. Pet cover 1206 includes top portion 1222, side skirt 1212, bottom skirt 1210. Pet cover 1206 has attached or releasably attached edges 1216, 1218, and 1220, and unattached edge 1214. The pet comforter 1200 is preferably sold as the top bedding 1204 with pet cover 1206 attached. In a particular embodiment, edge 1216 may be an opening, allowing a pet access between the bed covering 104 and the pet cover 1206 along the side of bed 102.

FIG. 13 is a perspective view illustrating another exemplary embodiment of a pet comforter 1300 on a bed 102, in accordance with a thirteenth preferred embodiment of the present invention. Pet comforter 1300 includes top bedding 104 and pet cover 1306. Pet cover 1306 has fasteners 1302 (one of four labeled) at each corner for fastening pet cover 1306 to top bedding 104. Edges 1308, 1310, 1312, and 1314 are not attached, except at the corners, allowing pet access from any side. The pet comforter 1300 is preferably sold as the top bedding 1304 with pet cover 1306 attached.

Any embodiment of the pet comforter, including illustrated embodiments 100, 200, 300, 400, 500, 600, 700, 800, 900, 1000, 1100, 1200, and 1300 may be made with antimicrobial or antibacterial materials; moisture barriers as a bottom layer of the pet cover 106, 206, 306, 406, 506, 606, 706, 806, 906, 1006, 1106, 1206, and 1306; and flea and tick suppressant materials. All materials are preferably environmentally friendly materials. Any embodiment of the pet comforter may bear decorative or functional colors and/or patterns.

FIG. 14 is a diagrammatic view illustrating an exemplary embodiment of a first pet comforter kit 1400, in accordance with a preferred embodiment of the present invention. Kit 1400 includes bed covering 104 with first parts 1402 (one of four labeled) of complimentary fasteners 1302 attached and a plurality pet covers 1306 and 1406 with second parts 1404 (one of four labeled on each pet cover 1306 and 1406) complimentary fasteners 1302 attached. The plurality of pet covers 1306 and 1406 is not intended to be limiting, nor is the type or configuration of fastener parts 1402 and 1404. While kit 1400 is based on pet comforter 1300, any embodiment with a releasably fastened pet cover may form a basis for kit 1400.

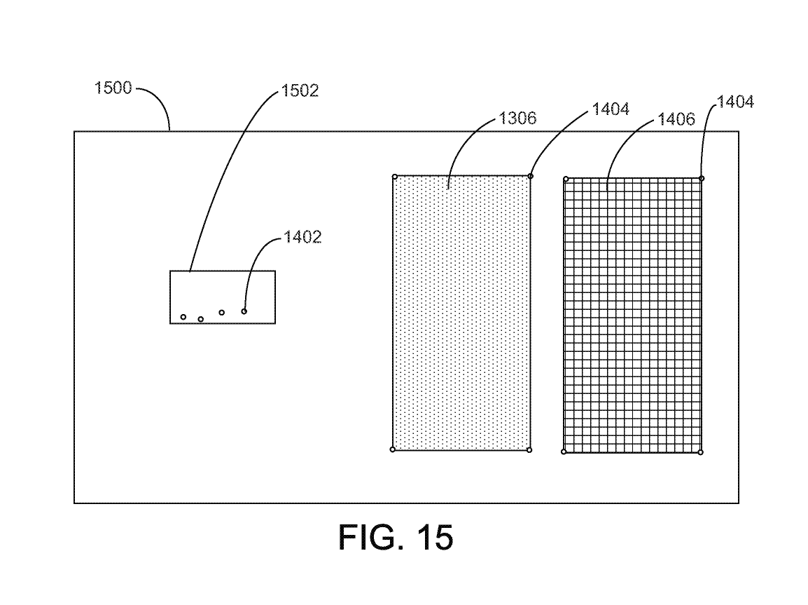

FIG. 15 is a diagrammatic view illustrating an exemplary embodiment of a second pet comforter kit 1500, in accordance with a preferred embodiment of the present invention. Kit 1500 includes a plurality of pet covers 1306 and 1406 and a plurality of complimentary fastener parts 1402, preferably in a container 1502, that the consumer can fasten to the consumer's legacy bed cover 104. The plurality of pet covers 1306 and 1406 is not intended to be limiting, nor is the type or configuration of fasteners 1402 and 1404. While kit 1500 is based on pet comforter 1300, any embodiment with a releasably fastened pet cover may form a basis for kit 1500.

Although applicant has described applicant's preferred embodiments of this invention, it will be understood that the broadest scope of this invention includes such modifications as diverse shapes and sizes and materials. Such scope is limited only by the below claims as read in connection with the above specification.

Further, many other advantages of applicant's invention will be apparent to those skilled in the art from the above descriptions and the below claims. For example, the invention may be used to hold objects as well as or instead of live pets. For further example, stuffed animals, teddy bears, toys generally, and electronic devices such as remote controls, may be placed under the pet cover.

1. A pet comforter comprising:
a. a bed covering for at least partially covering a bed that is sized for a human; and
b. a pet cover operable to be coupled to said bed covering and having at least one opening along at least a portion of at least one edge of said pet cover for enabling entrance between at least a portion of said pet cover and at least a portion of said bed covering by a pet.

2. The pet comforter of claim 1, wherein said pet cover is operable to be releasably coupled to said bed covering.

3. The pet comforter of claim 2, comprising a kit further comprising:
a. said bed covering; and
b. a plurality of various said pet covers operable to be releasably coupled to said bed covering.

4. The pet comforter of claim 1, wherein said pet cover comprises at least one opening for ventilation.

5. The pet comforter of claim 1, wherein said pet cover comprises at least one divider creating a plurality of compartments under said pet cover.

6. The pet comforter of claim 1, wherein said pet cover comprises a plurality of layers of fabric.

7. The pet comforter of claim 6, wherein said at least one opening comprises at least one opening between at least two layers of fabric of said plurality of layers of fabric.

8. The pet comforter of claim 6, wherein a layer of fabric of said plurality fabric layers that is abutting said bed covering comprises a moisture barrier.

9. The pet comforter of claim 1, wherein said pet cover has at least one edge coextensive with at least one edge of said bed covering.

10. The pet comforter of claim 1, wherein said pet cover has at least one edge coextensive with at least one edge of said bed.

11. The pet comforter of claim 1, wherein said pet cover comprises at least one of:
a. antimicrobial materials;
b. antibacterial materials; and
c. flea and tick suppressant materials.

12. A pet comforter comprising:
a. a bed covering for at least partially covering a bed that is sized for a human;
b. a pet cover operable to be coupled to said bed covering and having at least one opening along at least a portion of one edge of said pet cover for enabling entrance between at least a portion of said pet cover and at least a portion of said bed covering by a pet; and
c. wherein said pet cover comprises a plurality of fabric layers.

13. The pet comforter of claim 12, wherein said pet cover is operable to be releasably coupled to said bed covering.

14. The pet comforter of claim 13, comprising a first kit further comprising:
a. said bed covering; and
b. a plurality of various said pet covers operable to be releasably coupled to said bed covering.

15. The pet comforter of claim 12, wherein said pet cover comprises at least one of:
a. at least one opening for ventilation;
b. at least one divider creating a plurality of compartments under said pet cover; and
c. a moisture barrier.

16. The pet comforter of claim 12, wherein said pet cover comprises at least one of:
a. at least one edge coextensive with at least one edge of said bed covering; and
b. at least one edge coextensive with at least one edge of said bed.

17. The pet comforter of claim 12, wherein said pet cover comprises at least one of:
a. antimicrobial materials;
b. antibacterial materials; and
c. flea and tick suppressant materials.

18. The pet comforter of claim 14, comprising a second kit further comprising:
a. a first plurality of first parts of complimentary fasteners operable to be attached to said bed covering; and
b. a second plurality of various said pet covers each comprising at least a first plurality of second parts of said complimentary fasteners operable to be releasably coupled to said bed covering.

19. A pet comforter comprising:
a. a bed covering for at least partially covering a bed that is sized for a human;
b. a pet cover operable to be coupled to said bed covering and having at least one opening along at least a portion of one edge of said pet cover for enabling entrance between at least a portion of said pet cover and at least a portion of said bed covering by a pet; and
c. wherein said pet cover comprises at least one of:
i. a plurality of fabric layers;
ii. at least one releasable coupling; and
iii. at least one fixed coupling;
iv. antimicrobial materials;
v. antibacterial materials;
vi. flea and tick suppressant materials;
vii. at least one edge coextensive with at least one edge of said bed covering;
viii. at least one edge coextensive with at least one edge of said bed;
ix. at least one opening for ventilation;
x. at least one divider creating a plurality of compartments under said pet cover; and
xi. a moisture barrier.

20. The pet comforter of claim 19, comprising a kit further comprising at least one of:
a. a first kit further comprising:
i. said bed covering; and
ii. a plurality of various said pet covers operable to be releasably coupled to said bed covering; and
b. a second kit further comprising:
i. a first plurality of first parts of complimentary fasteners operable to be attached to said bed covering; and
ii. a second plurality of various said pet covers each comprising at least a first plurality of second parts of said complimentary fasteners operable to be releasably coupled to said bed covering.
